(19) United States
(12) Patent Application Publication
(10) Pub. No.: US 2022/0041903 A1
(43) Pub. Date: Feb. 10, 2022

(54) ADHESIVE FILM, OPTICAL MEMBER INCLUDING THE SAME, AND OPTICAL DISPLAY INCLUDING THE SAME

(71) Applicant: SAMSUNG SDI CO., LTD., Yongin-si (KR)

(72) Inventors: Do Young KIM, Suwon-si (KR); Young Jong KIM, Suwon-si (KR); Seung Hoon LEE, Suwon-si (KR); Seong Heun CHO, Suwon-si (KR); Ji Young HAN, Suwon-si (KR); IL Jin KIM, Suwon-si (KR)

(21) Appl. No.: 17/392,396

(22) Filed: Aug. 3, 2021

(30) Foreign Application Priority Data
Aug. 4, 2020 (KR) 10-2020-0097684

(51) Int. Cl. C09J 7/38; C09J 11/04; C09J 7/10

(52) U.S. Cl. CPC C09J 7/385; C09J 11/04; C09J 2433/00; C09J 2203/326; C09J 7/10

(57) ABSTRACT

An adhesive film, an optical member including the same, and an optical display including the same, the adhesive film being formed of an adhesive film composition, the adhesive film composition including a (meth)acrylic polymer having an aromatic group and a hydroxyl group; inorganic particles having an index of refraction of about 1.5 or more; and a crosslinking agent, wherein the adhesive film has a modulus of about 50 kPa to about 500 kPa at 25° C.

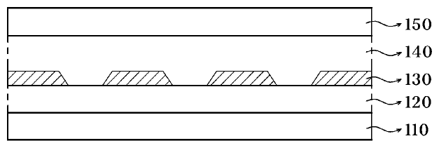

### CROSS—REFERENCE TO RELATED APPLICATION

This application claims the benefit of Korean Patent Application No. 10-2020-0097684, filed on Aug. 4, 2020, in the Korean Intellectual Property Office, the entire disclosure of which is incorporated herein by reference.

### BACKGROUND

### 1. Field

Embodiments relate to an adhesive film, an optical member including the same, and an optical display including the same.

### 2. Description of the Related Art

An optical display may include multiple optical elements stacked one above another. In general, the optical elements may be stacked by or using acrylic adhesive films. The optical elements may include various optical films including a touchscreen panel, a polarizing plate, and the like. Some optical elements may have a high index of refraction.

### SUMMARY

The embodiments may be realized by providing an adhesive film formed of an adhesive film composition, the adhesive film composition including a (meth)acrylic polymer having an aromatic group and a hydroxyl group; inorganic particles having an index of refraction of about 1.5 or more; and a crosslinking agent, wherein the adhesive film has a modulus of about 50 kPa to about 500 kPa at 25° C.

The adhesive film may have an index of refraction of about 1.5 or more.

The adhesive film may have a haze of about 2% or less.

The inorganic particles having an index of refraction of about 1.5 or more may include zirconia (ZrO₂).

The inorganic particles having an index of refraction of about 1.5 or more may have an average particle diameter (D50) of about 10 nm to about 50 nm.

The inorganic particles having an index of refraction of about 1.5 or more may be present in the adhesive film in an amount of about 1 wt % to about 50 wt %.

The (meth)acrylic polymer having an aromatic group and a hydroxyl group my include a copolymer of a monomer mixture, the monomer mixture including an aromatic group-containing (meth)acrylic monomer and a hydroxyl group-containing (meth)acrylic monomer.

The aromatic group-containing (meth)acrylic monomer may include a compound represented by Formula 1:

CH₂═C(R¹)—C(═O)—O—R²—Ar, [Formula 1]

in Formula 1, R¹ is a hydrogen atom or a methyl group; R² is a substituted or unsubstituted C₁ to C₁₀ alkylene group or a substituted or unsubstituted C₁ to C₁₀ alkylene oxide group; and Ar is a substituted or unsubstituted C₆ to C₂₀ monovalent aromatic hydrocarbon group.

The aromatic group-containing (meth)acrylic monomer may include phenoxy benzyl (meth)acrylate, phenyl phenoxy ethyl (meth)acrylate, 2-hydroxy-3-phenoxy propyl (meth)acrylate, ethoxylated phenyl phenoxy (meth)acrylate, or benzyl (meth)acrylate.

The monomer mixture may include about 80 wt % to about 99 wt % of the aromatic group-containing (meth)acrylic monomer, and about 1 wt % to about 20 wt % of the hydroxyl group-containing (meth)acrylic monomer.

The monomer mixture may further include at least one comonomer, the comonomer including an alkyl group-containing (meth)acrylic monomer, an alicyclic group-containing (meth)acrylic monomer, or a hetero-alicyclic group-containing (meth)acrylic monomer.

The crosslinking agent may be an isocyanate crosslinking agent.

The adhesive film composition may include about 45 wt % to about 95 wt % of the (meth)acrylic polymer having an aromatic group and a hydroxyl group, about 1 wt % to about 50 wt % of the inorganic particles having an index of refraction of about 1.5 or more, and about 0.001 wt % to about 1 wt % of the crosslinking agent.

The adhesive film may have a peel strength of about 100 gf/inch to about 3,000 gf/inch, and a value of about 1.5% or less as calculated by Equation 1:

{[Index of refraction of adhesive film]/[peel strength of adhesive film (gf/inch)]}×100. [Equation 1]

The embodiments may be realized by providing an optical member including an adherend for optical displays; and the adhesive film according to an embodiment on one surface of the adherend.

The embodiments may be realized by providing an optical display including the adhesive film according to an embodiment.

The embodiments may be realized by providing an adhesive film formed of an adhesive film composition, the adhesive film composition including a (meth)acrylic polymer having an aromatic group and a hydroxyl group; inorganic particles having an index of refraction of about 1.5 or more; and a crosslinking agent, wherein the adhesive film has a peel strength of about 100 gf/inch to about 3,000 gf/inch, and a value of about 1.5% or less, as calculated by Equation 1:

{[index of refraction of adhesive film]/[peel strength of adhesive film (gf/inch)]}×100. [Equation 1]

### BRIEF DESCRIPTION OF THE DRAWING

Features will be apparent to those of skill in the art by describing in detail exemplary embodiments with reference to the attached drawing in which:

The FIGURE is a partial sectional view of an optical display according to one embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figure, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

In the drawing, components unrelated to description are omitted for clear description of the embodiments and like components will be denoted by like reference numerals throughout the specification. Herein, spatially relative terms, such as “upper” and “lower”, are defined with reference to the accompanying drawings. Thus, it will be understood that the term “upper surface” can be used interchangeably with the term “lower surface”.

Herein, the term “(meth)acryl” refers to acryl or methacryl.

Herein, the term “polymer” may include an oligomer, a polymer, a copolymer, or a resin.

Herein, the term “modulus” means storage modulus.

Herein, the term “peel strength” refers to a value measured upon peeling a stacked structure of an adhesive film and a release film of a specimen from an alkali-free glass plate under conditions of a peeling temperature of 25° C., a peeling rate of 300 mm/min and a peeling angle of 180°, with the specimen coupled to a peel strength tester (TA (Texture Analyzer) Instrument), in which the specimen is prepared by sequentially stacking the adhesive film and the release film (for example, a polyethylene terephthalate film) on the alkali-free glass plate.

Herein, “index of refraction” and “haze” are values measured at a wavelength of 200 nm to 800 nm, e.g., at a wavelength of 550 nm.

As used herein to represent a specific numerical range, the expression “X to Y” means a value greater than or equal to X and less than or equal to Y (X≤and ≤Y). As used herein, the term “or” is not an exclusive term, e.g., “A or B” would include A, B, or A and B.

The embodiments may provide an adhesive film having a high index of refraction, high peel strength, and good step embedding properties. In addition, the embodiments may provide an adhesive film having low haze to provide good optical properties.

Hereinafter, an adhesive film according to one embodiment will be described.

The adhesive film according to the embodiment may have an index of refraction of about 1.5 or more. Within this range, the adhesive film may help improve efficiency of light extraction by reducing light reflection while preventing deterioration in screen quality due to difference in index of refraction when stacked on an adherend having a high index of refraction. In an implementation, the adhesive film may have an index of refraction of, e.g., about 1.5, about 1.55, about 1.6, about 1.65, or about 1.7. In an implementation, the adhesive film may have an index of refraction of, e.g., about 1.55 or more, or about 1.55 to about 1.7. Within this range, manufacturing of the adhesive film according to an embodiment may be facilitated.

Herein, “adherend” refers to an optical element stacked on a light emitting diode panel in an optical display and may include, e.g., an optical element that includes a touchscreen panel, a glass plate, a plastic film, a conductive layer, or the like. In an implementation, the adherend may have an index of refraction of about 1.4 or more, e.g., 1.4 to 1.8.

In an implementation adhesive film has a peel strength of about 100 gf/inch to about 3,000 gf/inch, and an Equation 1 value of about 1.5% or less. Within this range, the adhesive film may help prevent deterioration in screen quality when applied to a highly refractive adherend, may allow light guiding as an optical element, and may be secured to the highly refractive adherend with high peel strength, thereby providing high reliability.

[Index of refraction of adhesive film]/[peel strength of adhesive film (gf/inch)]×100. [Equation 1]

The above Equation 1 value indicates that the adhesive film has a high index of refraction and high peel strength. If the adhesive film having an index of refraction of about 1.5 or more were to have a peel strength of less than 100 gf/inch, the adhesive film would not satisfy an Equation 1 value of 1.5% or less, or would not provide high reliability when secured to a highly refractive adherend with high peel strength. In an implementation, the adhesive film may have an Equation 1 value of, e.g., about 0.001%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, or 1.5%. In an implementation, the adhesive film may have an Equation 1 value of greater than about 0% to 1.5%, e.g., 0.01% to 1.5%, or 0.1% to 1%.

In an implementation, the adhesive film may have a modulus of, e.g., about 50 kPa to about 500 kPa at 25° C. Within this range, the adhesive film may exhibit good step embedding properties. In an implementation, the adhesive film may exhibit good step embedding properties when adhesively attached to a glass plate that includes a pattern having a thickness of about 2 μm or more thereon, e.g., a thickness of about 2 μm to 10 μm, or to a patterned substrate of silicon nitride (SiNx) or an acrylic material. In an implementation, the adhesive film may have a modulus at 25° C. of, e.g., about 50 kPa, 60 kPa, 70 kPa, 80 kPa, 90 kPa, 100 kPa, 110 kPa, 120 kPa, 130 kPa, 140 kPa, 150 kPa, 160 kPa, 170 kPa, 180 kPa, 190 kPa, 200 kPa, 210 kPa, 220 kPa, 230 kPa, 240 kPa, 250 kPa, 260 kPa, 270 kPa, 280 kPa, 290 kPa, 300 kPa, 310 kPa, 320 kPa, 330 kPa, 340 kPa, 350 kPa, 360 kPa, 370 kPa, 380 kPa, 390 kPa, 400 kPa, 410 kPa, 420 kPa, 430 kPa, 440 kPa, 450 kPa, 460 kPa, 470 kPa, 480 kPa, 490 kPa, or 500 kPa. In an implementation, the adhesive film may have a modulus of about 50 kPa to about 300 kPa, e.g., about 100 kPa to about 200 kPa, at 25° C.

In order to satisfy all of the index of refraction, peel strength, and step embedding properties, the adhesive film may be formed of or from a composition for adhesive films described below. Next, the composition for adhesive films will be described.

The composition for adhesive films may include, e.g., a (meth)acrylic polymer having an aromatic group and a hydroxyl group, a crosslinking agent, and inorganic particles having an index of refraction of about 1.5 or more.

In the composition for adhesive films, the (meth)acrylic polymer having an aromatic group and a hydroxyl group may provide the above-described desirable peel strength upon curing with a curing agent, while also securing the above-described desirable index of refraction and modulus, together with the inorganic particles having an index of refraction of about 1.5 or more. In an implementation, the (meth)acrylic polymer having an aromatic group and a hydroxyl group may exhibit good compatibility with the inorganic particles having an index of refraction of about 1.5 or more to assist in improvement in step embedding properties of the adhesive film. The (meth)acrylic polymer having an aromatic group and a hydroxyl group may be used together with the inorganic particles having an index of refraction of about 1.5 or more, e.g., zirconia, whereby the adhesive film may have an index of refraction of about 1.55 or more. In an implementation, the (meth)acrylic polymer having an aromatic group and a hydroxyl group may help reduce haze of the adhesive film to 2% or less by improving dispersion of the inorganic particles having an index of refraction of about 1.5 or more in the adhesive film. A hydroxyl group-containing (meth)acrylic polymer free from an aromatic group may not improve haze of the adhesive film, e.g., due to difficulties dispersing the inorganic particles having an index of refraction of about 1.5 or more in the adhesive film.

The (meth)acrylic polymer having an aromatic group and a hydroxyl group may include a copolymer of a monomer mixture including an aromatic group-containing (meth)acrylic monomer and a hydroxyl group-containing (meth)acrylic monomer. In contrast, an adhesive film formed of a composition including an aromatic group-containing (meth)acrylic monomer, a hydroxyl group-containing (meth)acrylic monomer, and a photopolymerization initiator, instead of the (e.g., pre-prepared) (meth)acrylic copolymer having an aromatic group and a hydroxyl group, through photo curing may not satisfy the modulus conditions described above.

The aromatic group-containing (meth)acrylic monomer may include a substituted or unsubstituted aromatic group-containing (meth)acrylic monomer.

Herein, “substituted” in “substituted or unsubstituted” means that a hydrogen atom in an aromatic group is substituted or replaced with a C₁ to C₁₀ alkyl group, a C₆ to C₁₀ aryl group, a C₆ to C₁₀ aryloxy group, a hydroxyl group, a halogen, an amino group, or a cyano group. Herein, “aromatic group” may mean a monocyclic or polycyclic aromatic ring.

In an implementation, the substituted or unsubstituted aromatic group-containing (meth)acrylic monomer may include, e.g., a compound of Formula 1.

CH₂═C(R¹)—C(═O)—O—R²—Ar [Formula 1]

In Formula 1, R¹ may be or include, e.g., a hydrogen atom or a methyl group.

R² may be or include, e.g., a substituted or unsubstituted C₁ to C₂₀ alkylene group or a substituted or unsubstituted C₁ to C₂₀ alkylene oxide group.

Ar may be or include, e.g., a substituted or unsubstituted C₆ to C₂₀ monovalent aromatic hydrocarbon group.

Here, “alkylene oxide group” means *-[—X—O-]n-* (* indicating a linking site of an element, X indicating a substituted or unsubstituted C₁ to C₂₀ alkylene group, and n being an integer of 1 to 20).

In an implementation, the aromatic group-containing (meth)acrylic monomer may include, e.g., a (meth)acrylic monomer having at least one substituted or unsubstituted aromatic group. In an implementation, the aromatic group-containing (meth)acrylic monomer may include, e.g., a (meth)acrylic monomer having at least two substituted or unsubstituted aromatic groups. A (meth)acrylic monomer having at least two substituted or unsubstituted aromatic groups may allow the adhesive film to secure the index of refraction within a desirable range through combination with the inorganic particles.

In an implementation, in Formula 1, Ar may be, e.g., a substituted or unsubstituted C₆ to C₂₀ aryl group or a substituted or unsubstituted C₆ to C₂₀ aryloxy group. In an implementation, in Formula 1, Ar may be substituted with, e.g., a C₆ to C₁₀ aryl group or a C₆ to C₁₀ aryloxy group.

In an implementation, the aromatic group-containing (meth)acrylic monomer may include a mixture of a monomer obtained through substitution of Ar of Formula 1 with a C₆ to C₁₀ aryl group and a monomer obtained through substitution of Ar of Formula 1 with a C₆ to C₁₀ aryloxy group. In an implementation, the composition for adhesive films may realize the desirable effects described above.

In an implementation, the aromatic group-containing (meth)acrylic monomer may include, e.g., phenoxy benzyl (meth)acrylate, phenyl phenoxy ethyl (meth)acrylate, 2-hydroxy-3-phenoxypropyl (meth)acrylate, ethoxylated phenyl phenoxy (meth)acrylate, or benzyl (meth)acrylate.

The aromatic group-containing (meth)acrylic monomer may have a glass transition temperature of about −80° C. to about 30° C. in a homopolymer phase, e.g., about −80° C., about −75° C., about −70° C., about −65° C., about −60° C., about −55° C., about −50° C., about −45° C., about −40° C., about −35° C., about −30° C., about −25° C., about −20° C., about −15° C., about −10° C., about −5° C., about 0° C., about 5° C., about 10° C., about 15° C., about 20° C., about 25° C., or about 30° C., or about −40° C. to about 10° C. Within this range, the composition allows the adhesive film to realize target modulus at room temperature.

In an implementation, in the monomer mixture, the aromatic group-containing (meth)acrylic monomer may be present in an amount of about 80 wt % to about 99 wt %, e.g., about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, or about 85 wt % to about 95 wt % (e.g., based on a total weight of the monomer mixture). Within this range, the composition may allow the adhesive film to realize the index of refraction and modulus within the aforementioned ranges.

The hydroxyl group-containing (meth)acrylic monomer may help secure peel strength of the adhesive film. The hydroxyl group-containing (meth)acrylic monomer may include, e.g., a (meth)acrylate having at least one hydroxyl group. In an implementation, the hydroxyl group-containing (meth)acrylate may include, e.g., a C₂ to C₁₀ alkyl group-containing (meth)acrylate having at least one hydroxyl group. In an implementation, the hydroxyl group-containing (meth)acrylate may include, e.g., 2-hydroxy ethyl (meth)acrylate, 2-hydroxy propyl (meth)acrylate, 3-hydroxy propyl (meth)acrylate, 2-hydroxy butyl (meth)acrylate, 4-hydroxy butyl (meth)acrylate, or 6-hydroxy hexyl (meth)acrylate. In an implementation, the hydroxyl group-containing (meth)acrylate may include, e.g., 4-hydroxy butyl (meth)acrylate, 2-hydroxy ethyl (meth)acrylate, 6-hydroxy hexyl (meth)acrylate, or 3-hydroxy propyl (meth)acrylate.

In an implementation, in the monomer mixture, the hydroxyl group-containing (meth)acrylic monomer may be present in an amount of about 1 wt % to about 20 wt %, e.g., about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, or about 5 wt % to about 15 wt % (e.g., based on the total weight of the monomer mixture). Within this range, the adhesive film may achieve improvement in peel strength with respect to an adherend.

In an implementation, the monomer mixture may include about 80 wt % to about 99 wt % of the aromatic group-containing (meth)acrylic monomer and about 1 wt % to about 20 wt % of the hydroxyl group-containing (meth)acrylic monomer. Within this range, the composition may realize the desirable effects described above.

In an implementation, the monomer mixture may further include a comonomer, e.g., an alkyl group-containing (meth)acrylic monomer, an alicyclic group-containing (meth)acrylic monomer, or a hetero-alicyclic group-containing (meth)acrylic monomer.

The alkyl group-containing (meth)acrylic monomer may help improve mechanical strength of the adhesive film. The alkyl group-containing (meth)acrylic monomer may include, e.g., an unsubstituted C₁ to C₂₀ linear or branched alkyl group-containing (meth)acrylate. In an implementation, the alkyl group-containing (meth)acrylate may include, e.g., methyl (meth)acrylate, ethyl (meth)acrylate, propyl (meth)acrylate, n-butyl (meth)acrylate, t-butyl (meth)acrylate, iso-butyl (meth)acrylate, pentyl (meth)acrylate, hexyl (meth)acrylate, heptyl (meth)acrylate, ethyl hexyl (meth)acrylate including 2-ethyl hexyl (meth)acrylate and the like, octyl (meth)acrylate, isooctyl (meth)acrylate, nonyl (meth)acrylate, decyl (meth)acrylate, or lauryl (meth)acrylate.

The alicyclic group-containing (meth)acrylic monomer and the hetero-alicyclic group-containing (meth)acrylic monomer may include suitable monomers.

In an implementation, the comonomer may be present in an amount of about 30 wt % or less, e.g., about 0.1 wt % to about 30 wt %, in the monomer mixture. Within this range, the comonomer may help realize inherent effects thereof without affecting the effects of the adhesive film according to an embodiment.

The (meth)acrylic polymer having an aromatic group and a hydroxyl group may have a weight average molecular weight of about 500,000 to about 4,000,000, e.g., about 50,000, about 100,000, about 150,000, about 200,000, about 250,000, about 300,000, about 350,000, about 400,000, or about 500,000 to about 2,000,000. Within this range, the composition may realize the desirable effects described above.

The (meth)acrylic polymer having an aromatic group and a hydroxyl group may be prepared through polymerization of the monomer mixture by a suitable method. Polarization may be performed by a suitable method.

The inorganic particles having an index of refraction of about 1.5 or more may help improve the index of refraction of the adhesive film such that the adhesive film may achieve a target index of refraction described above.

The inorganic particles having an index of refraction of about 1.5 or more may have an index of refraction of, e.g., about 1.5, about 1.55, about 1.6, about 1.65, about 1.7, about 1.75, about 1.8, about 1.85, about 1.9, about 1.95, about 2, about 2.05, about 2.1, about 2.15, about 2.2, about 2.25, about 2.3, about 2.35, about 2.4, about 2.45, about 2.5, about 2.55, about 2.6, about 2.65, about 2.7, about 2.75, or about 2.8. In an implementation, the inorganic particles having an index of refraction of about 1.5 or more have an index of refraction of, e.g., about 1.5 to about 2.8, or about 1.5 to about 1.7. Within this range, the composition may allow the adhesive film to realize the index of refraction within the aforementioned range.

The inorganic particles having an index of refraction of about 1.5 or more may include suitable inorganic particles. In an implementation, the inorganic particles having an index of refraction of about 1.5 or more may include, e.g., zirconia (ZrO₂) or titania (TiO₂). In an implementation, the inorganic particles having an index of refraction of about 1.5 or more may include, e.g., zirconia.

The inorganic particles having an index of refraction of about 1.5 or more may have an average particle diameter (D50) of about 10 nm to about 50 nm, e.g., about 10 nm, about 15 nm, about 20 nm, about 25 nm, about 30 nm, about 35 nm, about 40 nm, about 45 nm, or about 50 nm. In an implementation, the inorganic particles having an index of refraction of about 1.5 or more may have, e.g., an average particle diameter (D50) of about 20 nm to about 30 nm. Within this range, the inorganic particles may not affect peel strength and haze of the adhesive film. Here, “average particle diameter (D50)” may be measured by a suitable method. In an implementation, “D50” may be a particle diameter corresponding to 50 wt % in a weight cumulative distribution of the inorganic particles, as measured using a particle size analyzer.

The inorganic particles having an index of refraction of about 1.5 or more may be subjected to surface treatment to help reduce haze of the adhesive film by improving dispersion upon mixing with the copolymer. Surface treatment may be performed by a suitable method. In an implementation, the inorganic particles having an index of refraction of about 1.5 or more may be subjected to surface treatment with a (meth)acrylic compound.

The inorganic particles having an index of refraction of about 1.5 or more may be present in an amount of, e.g., about 1 wt % to about 50 wt %, in the adhesive film (e.g., based on a total weight of the adhesive film or based on a total weight of the composition for forming the adhesive film). The inorganic particles having an index of refraction of about 1.5 or more may be present in an amount of, e.g., about 1 wt %, about 5 wt %, about 10 wt %, about 20 wt %, about 25 wt %, about 30 wt %, about 35 wt %, about 40 wt %, about 45 wt %, about 50 wt %, or about 4 wt % to about 50 wt %, in the adhesive film. Within this range, the adhesive film may achieve an index of refraction of about 1.5 or more and good peel strength while satisfying a modulus condition to provide good step embedding properties.

The inorganic particles having an index of refraction of about 1.5 or more may be present in an amount of, e.g., about 1 part by weight to about 150 parts by weight, relative to 100 parts by weight of the (meth)acrylic polymer having an aromatic group and a hydroxyl group. In an implementation, the inorganic particles may be present in an amount of, e.g., about 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, or 150 parts by weight, relative to 100 parts by weight of the (meth)acrylic polymer. In an implementation, the inorganic particles may be present in an amount of about 5 parts by weight to about 120 parts by weight relative to 100 parts by weight of the (meth)acrylic polymer. Within this range, the adhesive film can secure an index of refraction of 1.5 or more and may achieve high peel strength and good modulus.

The (meth)acrylic polymer having an aromatic group and a hydroxyl group may help improve peel strength of the adhesive film through reaction with the crosslinking agent.

The crosslinking agent may provide peel strength to the adhesive film through heat curing of the (meth)acrylic polymer having an aromatic group and a hydroxyl group. The crosslinking agent may be a heat curable crosslinking agent which cures the composition with heat without UV irradiation and may help prevent damage to a light emitting diode by UV irradiation when the adhesive film is stacked on a light emitting diode panel or the like.

The crosslinking agent may include, e.g., an isocyanate crosslinking agent. The isocyanate crosslinking agent may help improve peel strength through reaction with the hydroxyl group in the (meth)acrylic polymer having an aromatic group and a hydroxyl group.

The isocyanate crosslinking agent may include a bi- or higher functional, e.g., a bi- to hexa-functional isocyanate crosslinking agent. In an implementation, the isocyanate crosslinking agent may include linear aliphatic isocyanate crosslinking agents, e.g., hexamethylene diisocyanate, pentamethylene diisocyanate, or the like; aromatic isocyanate crosslinking agents, e.g., toluene diisocyanate, diphenyl methane diisocyanate, phenylene diisocyanate, xylylene diisocyanate, naphthalene diisocyanate, tetramethyl xylene diisocyanate, or the like; or adducts thereof. In the linear aliphatic group-containing isocyanate crosslinking agents, e.g., hexamethylene diisocyanate, pentamethylene diisocyanate, or the like, the linear aliphatic group may facilitate an improvement in foldability of the adhesive film by providing flexible properties to the adhesive film while reducing modulus of the adhesive film.

In an implementation, the crosslinking agent may be present in an amount of, e.g., about 0.001 parts by weight to about 10 parts by weight, relative to 100 parts by weight of the (meth)acrylic polymer having an aromatic group and a hydroxyl group. Within this range, the adhesive film may achieve improvement in peel strength and foldability at low temperature and high temperature. In an implementation, the crosslinking agent may be present in an amount of, e.g., about 0.001, 0.005, 0.01, 0.05, 0.15, 0.2, 0.25, 0.3, 0.35, 0.4, 0.45, 0.5, 0.55, 0.6, 0.65, 0.7, 0.75, 0.8, 0.9, 0.95, 1, 1.5, 2, 2.5, 3, 3.5, 4, 4.5, 5, 5.5, 6, 6.5, 7, 7.5, 8, 8.5, 9, 9.5, or 10 parts by weight, relative to 100 parts by weight of the (meth)acrylic polymer. In an implementation, the crosslinking agent may be present in an amount of, e.g., about 0.01 parts by weight to about 2.0 parts by weight, or about 0.01 parts by weight to about 1.0 part by weight, relative to 100 parts by weight of the (meth)acrylic polymer.

In an implementation, the composition may include, e.g., about 45 wt % to about 95 wt % of the (meth)acrylic polymer having an aromatic group and a hydroxyl group, about 1 wt % to about 50 wt % of the inorganic particles having an index of refraction of about 1.5 or more, and about 0.001 wt % to about 1 wt % of the crosslinking agent (e.g., based on a total weight of the composition). Within this range, the composition may facilitate formation of the adhesive film. In an implementation, the polymer may be present in an amount of, e.g., about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, or about 95 wt % in the composition. In an implementation, the inorganic particles may be present in an amount of, e.g., about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, or about 50 wt % in the composition. In an implementation, the inorganic particles may be present in an amount of, e.g., 4 wt % to 50 wt % in the composition. Within this range, the adhesive film may achieve an index of refraction of 1.5 or more and peel strength while satisfying a target modulus to provide good step embedding properties. In an implementation, the crosslinking agent may be present in an amount of, e.g., about 0.001 wt %, about 0.005 wt %, about 0.01 wt %, about 0.05 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt % in the composition. In an implementation, the crosslinking agent may be present in an amount of, e.g., 0.001 wt % to 0.05 wt % in the composition.

In an implementation, the composition may further include a silane coupling agent to help improve peel strength of the adherend.

In an implementation, the silane coupling agent may include a suitable silane coupling agent. In an implementation, the silane coupling agent may be present in an amount of, e.g., about 0.001 parts by weight to about 1 part by weight, about 0.003 parts by weight to about 1 part by weight, or about 0.005 parts by weight to about 1 part by weight, relative to 100 parts by weight of the (meth)acrylic polymer having an aromatic group and a hydroxyl group.

In an implementation, the composition may further include a suitable additive, e.g., an antistatic agent, a surfactant, a curing accelerator, an ionic liquid, a lithium salt, an inorganic filler, a softener, a molecular weight regulator, an antioxidant, an anti-aging agent, a stabilizer, a tackifier resin, a modification resin (a polyol resin, a phenol resin, an acrylic resin, a polyester resin, a polyolefin resin, an epoxy resin, an epoxidated polybutadiene resin, or the like), a leveling agent, a defoaming agent, a plasticizer, dyes, pigments (a coloring pigment, an extender pigment, or the like), a treatment agent, a UV-blocking agent, a fluorescent whitening agent, a dispersant, a heat stabilizer, a light stabilizer, a UV absorbent, a coagulant, a lubricant, or the like. The additive may be present in an amount of, e.g., about 0.001 parts by weight to about 1 part by weight, about 0.003 parts by weight to about 1 parts by weight, or about 0.005 parts by weight to about 1 part by weight, relative to 100 parts by weight of the (meth)acrylic polymer having an aromatic group and a hydroxyl group. Within this range, the adhesives may help secure inherent effects thereof without affecting peel strength and reliability of the adhesive film.

In an implementation, the composition may further include a solvent. The solvent may help improve coatability of the composition. The solvent may include a suitable solvent, e.g., methyl ethyl ketone or the like. The solvent may be present in the balance excluding a solid content in the composition.

The adhesive film may be manufactured by coating the composition to a predetermined thickness on a base film, followed by heat curing (aging). In an implementation, the base film may include a polyester film, e.g., polyethylene terephthalate or the like. The base film may have a thickness of about 10 μm to about 100 μm, e.g., about 50 μm to about 80 μm. In an implementation, heat curing may be performed by heat treatment, e.g., at about 50° C. to about 120° C. for about 1 to 5 days.

The adhesive film may have a haze of about 2% or less. In an implementation, the adhesive film may have a haze of, e.g., about 0%, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, or about 2%. In an implementation, the adhesive film may have a haze of, e.g., about 0% to about 1%. Within this range, the adhesive film may be suitably used in an optical display.

In an implementation, the adhesive film may have a thickness of about 10 μm to about 100 μm, e.g., about 10 μm to about 50 μm. Within this range, the adhesive film may be suitably used in an optical display.

Next, an optical member according to one embodiment will be described.

The optical member according to an embodiment may include, e.g., an adherend for optical displays and an adhesive film on one surface of the adherend. In an implementation, the adhesive film may include the adhesive film according to an embodiment.

The adherend for optical displays may include not only the aforementioned adherend but also an optical film or the like. In an implementation, the optical film may include, e.g., a window film and a protective film for the window film.

Next, an optical display according to an embodiment will be described.

The optical display according to an embodiment may include the adhesive film or the optical member according to an embodiment. The optical display may include a light emitting diode display, e.g., an organic light emitting diode display or the like, or a liquid crystal display. In an implementation, the optical display may include, e.g., a flexible display or a non-flexible display.

Referring to the FIGURE, the optical display may include a light emitting diode panel 110; and a touchscreen panel 120, an adhesive film 140 and an optical film 150 sequentially stacked on an upper surface of the light emitting diode panel 110. A passivation layer 130 may be formed in a predetermined pattern on or at an interface between the touchscreen panel 120 and the adhesive film 140.

The light emitting diode panel 110 may include red (R), green (G) and blue (B) light emitting diodes and may emit light for operation of the optical display.

When a user touches a screen of the optical display with a finger or a pen, the touchscreen panel 120 locates a touched portion on the screen of the optical display to receive input data through the screen such that the optical display operates in response to the input data. The touchscreen panel 120 may be formed of a metallic material, e.g., aluminum, titanium, or the like, and may have an index of refraction of 2 or more, e.g., 2 to 4.

The passivation layer 130 and the adhesive film 140 may help improve light extraction efficiency by reducing difference in index of refraction between the touchscreen panel 120 and the optical film 150. As shown in the FIGURE, the passivation layer 130 may have a predetermined pattern to help improve efficiency in extraction of light emitted from the touchscreen panel 120 to the adhesive film 140.

The adhesive film 140 may include the adhesive film according to an embodiment. The touchscreen panel 120 may directly contact the adhesive film 140. The adhesive film according to an embodiment may have a high index of refraction and may exhibit good peel strength and step embedding properties.

The optical film 150 may include a window film, a window, a polarizing plate, a color filter, a retardation film, an elliptically polarizing film, a reflective polarizing film, an anti-reflection film, a compensation film, a brightness enhancement film, an alignment film, a light diffusion film, a shatterproof film, a surface protection film, or the like. In an implementation, the optical film 150 may include a polarizing plate.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLE 1

In terms of solid content, 100 parts by weight of a monomer mixture comprising 90 parts by weight of an aromatic group-containing acrylic monomer (PBA-001, Formula 2-1, Tg in homopolymer phase: −35° C., phenoxy benzyl acrylate, Hannong Chemical Inc.) and an aromatic group-containing acrylic monomer (PP-011, Formula 2-2, Tg in homopolymer phase: −10° C. to 0° C., phenyl phenoxy ethyl acrylate, Hannong Chemical Inc.) and 10 parts by weight of 4-hydroxy butyl acrylate (Osaka Organic Chemistry Inc.) was dispersed in ethyl acetate, followed by adding 0.03 parts by weight of photopolymerization initiators Irgacure 127 and Irgacure 651 mixed in a predetermined ratio thereto. An aromatic group and hydroxyl group-containing (meth)acrylic copolymer A was prepared through UV polymerization of the monomer mixture under nitrogen purging conditions.

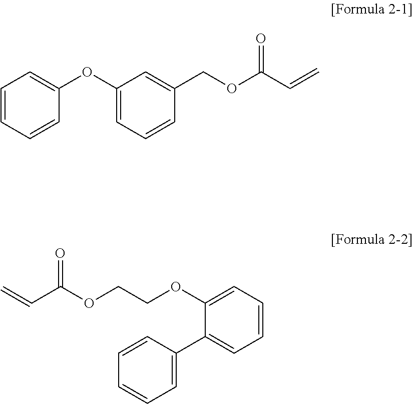

In terms of solid content, 0.01 parts by weight of an isocyanate crosslinking agent Coronate L-45 (aromatic isocyanate curing agent, Soken Inc.) was added to 100 parts by weight of the prepared (meth)acrylic copolymer A.

Next, a zirconia-containing sol (ZP-158, average particle diameter (D50) of zirconia: 20 nm, index of refraction of zirconia: 1.67, Nippon Shokubai Inc.) was added thereto.

The content of each component is shown in Table 1 in terms of solid content.

After removal of bubbles from the composition, the composition was coated to a thickness of 20 μm on one surface of a first release film (PET (polyethylene terephthalate) film, thickness: 75 SKC) to form a coating layer. A second release film (PET film, thickness: 75 SKC) was placed on the coating layer and dried at 120° C. for 2 minutes, followed by aging at 50° C. for 2 days.

As a result, an adhesive sheet of first release film/adhesive film (thickness: 20 μm to 25 μm)/second release film was prepared.

### EXAMPLES 2 AND 3

Adhesive sheets of first release film/adhesive film (thickness: 20 μm to 25 μm)/second release film were prepared in the same manner as in Example except that details of the compositions (unit: parts by weight) were changed as listed in Table 1.

### COMPARATIVE EXAMPLE 1

In terms of solid content, 100 parts by weight of a monomer mixture comprising 90 parts by weight of 2-ethyl hexyl acrylate (Chemical Inc.) and 10 parts by weight of 4-hydroxy butyl acrylate (Osaka Organic Chemistry Inc.) was dispersed in ethyl acetate, followed by adding 0.03 parts by weight of a photopolymerization initiator (Irgacure 651) thereto. A hydroxyl group-containing (meth)acrylic copolymer B was prepared through UV polymerization of the monomer mixture under nitrogen purging conditions.

An adhesive sheet of first release film/adhesive film (thickness: 20 μm to 25 μm)/second release film was prepared in the same manner as in Example except that the hydroxyl group-containing (meth)acrylic copolymer B was used and details of the composition (unit: parts by weight) were changed as listed in Table 1.

### COMPARATIVE EXAMPLE 2

An adhesive sheet of first release film/adhesive film/second release film was prepared in the same manner as in Comparative Example 1 except that details of the composition (unit: parts by weight) were changed as listed in Table 1.

### COMPARATIVE EXAMPLE 3

An adhesive sheet of first release film/adhesive film (thickness: 20 μm to 25 μm)/second release film was prepared in the same manner as in Example except that details of the composition (unit: parts by weight) were changed as listed in Table 1.

TABLE 1

| | Binder | | Crosslinking agent | Zirconia |
|---|---|---|---|---|
| | Kind | Content | Content | Content |
| Example 1 | A | 94.99 | 0.01 | 5 |
| Example 2 | A | 69.99 | 0.01 | 30 |
| Example 3 | A | 49.99 | 0.01 | 50 |
| Comparative | B | 99.99 | 0.01 | 0 |
| Example 1 | | | | |
| Comparative | B | 69.99 | 0.01 | 30 |
| Example 2 | | | | |
| Comparative | A | 9.99 | 0.01 | 90 |
| Example 3 | | | | |

The adhesive sheets of the Examples and Comparative Examples were evaluated as to properties listed in Table 2, and results are shown in Table 2.

(1) Peel strength (unit: gf/inch): Each of the adhesive sheets of first release film/adhesive film/second release film prepared in the Examples and Comparative Examples was cut into a rectangular sample having a size of 2.5 cm×10 cm (width×length). Then, the first release film was removed from the sample and a stack of the adhesive film and the second release film was attached to an alkali-free glass plate, followed by autoclaving, thereby preparing a specimen. The specimen was attached to a texture analyzer (TA) instrument, followed by measuring peel strength by separating the stack of the adhesive film and the second release film from the alkali-free glass plate under conditions of a peeling temperature of 25° C., a peeling rate of 300 mm/min and a peeling angle of 180°.

(2) Index of refraction: The adhesive film was removed from each of the adhesive sheets of first release film/adhesive film/second release film prepared in the Examples and Comparative Examples and measured as to the index of refraction using a prism coupler.

(3) Haze (unit: %): The adhesive film was obtained by removing the release films from each of the adhesive sheets of first release film/adhesive film/second release film prepared in the Examples and Comparative Examples and was attached to an alkali-free glass plate. Then, haze of the adhesive film was measured using a haze meter NDH-9,000.

(4) Step embedding properties: The adhesive film was obtained by removing the release films from each of the adhesive sheets of first release film/adhesive film/second release film prepared in the Examples and Comparative Examples and was cut into a rectangular sample having a size of 2.5 cm×10 cm (width×length). The adhesive film was attached to an upper surface of a glass plate having a 2 μm thick pattern thereon at 3.5 bar and at 55° C. Generation of bubbles at an interface between the adhesive film and the glass plate was observed through a microscope. Generation of no bubbles was rated as OK and generation of any bubbles was rated as NG.

(5) Modulus (unit: kPa): Viscoelasticity was measured under temperature sweep conditions using an ARES rheometer (MCR-501, Anton Parr) as a dynamic viscoelasticity instrument. Plural adhesive films prepared in each of the Examples and Comparative Examples were stacked to form a 600 μm thick stack. The stack was punched by an 8 mm diameter punching machine, thereby preparing a specimen. With a normal force of 1.0 N applied to the specimen using an 8 mm jig, modulus was measured at 25° C. while increasing temperature from −60° C. to 90° C. at a rate of 5° C./min under conditions of a shear rate of 1 Hz and a strain of 1%.

TABLE 2

| | Peel | Index of | | | Step embedding | |
|---|---|---|---|---|---|---|
| | strength | refraction | Equation 1 (%) | Haze | properties | Modulus |
| Example 1 | 1800 | 1.56 | 0.086 | 0.1 | OK | 50 |
| Example 2 | 1200 | 1.60 | 0.133 | 0.3 | OK | 160 |
| Example 3 | 500 | 1.65 | 0.33 | 0.5 | OK | 300 |
| Comparative | 1500 | 1.48 | 0.099 | 0.2 | OK | 40 |
| Example 1 | | | | | | |
| Comparative | 200 | 1.52 | 0.76 | 15.6 | NG | 250 |
| Example 2 | | | | | | |
| Comparative | 30 | 1.74 | 5.8 | 1.0 | NG | 510 |
| Example 3 | | | | | | |

As shown in Table 2, the adhesive films according to the Examples had an index of refraction of 1.5 or more, a peel strength of 100 gf/inch to 3,000 gf/inch, and a modulus of 50 kPa to 500 kPa. Accordingly, the adhesive films according to the Examples would exhibit improved screen quality and efficiency in extraction of light upon attachment to an adherend having a high index of refraction while securing good attachment reliability and good step embedding properties.

On the contrary, the adhesive film of Comparative Example 1 (including neither the (meth)acrylic polymer having an aromatic group and a hydroxyl group nor zirconia) failed to achieve a desirable index of refraction. The adhesive film of Comparative Example 2 (including zirconia but free of the (meth)acrylic polymer having an aromatic group and a hydroxyl group) had high haze and failed to achieve a haze of 2% or less, and thus was unsuitable for use in an optical display. The adhesive film of Comparative Example 3 (including an excess of zirconia) had low peel strength and failed to achieve a desirable modulus condition.

By way of summation and review, there may be a significant difference in index of refraction between an acrylic adhesive film and an optical element having a high index of refraction, e.g., a touchscreen panel or a polarizing plate. Such a difference in index of refraction could affect screen quality. An adhesive film or an optical film of a highly refractive layer capable of reducing the difference in index of refraction may be between the acrylic adhesive film and the optical element. However, the separate adhesive film or optical film could increase the thickness of an optical display and may require an additional process, thereby causing deterioration in processability and economic feasibility.

Indices of refraction of the acrylic adhesive film may be increased. However, an acrylic adhesive film having a high index of refraction may have low peel strength and poor optical properties, such as haze and the like.

An adhesive film may be stacked on an optical element having a flat surface or a predetermined pattern thereon. When the adhesive film is staked on the optical element without generation of bubbles, the adhesive film may be evaluated as having good step embedding properties.

One or more embodiments may provide an adhesive film having a high index of refraction and high peel strength. One or more embodiments may provide an adhesive film having good step embedding properties. One or more embodiments may provide an adhesive film having low haze.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An adhesive film formed of an adhesive film composition, the adhesive film composition comprising:
a (meth)acrylic polymer having an aromatic group and a hydroxyl group;
inorganic particles having an index of refraction of about 1.5 or more; and
a crosslinking agent,
wherein the adhesive film has a modulus of about 50 kPa to about 500 kPa at 25° C.

2. The adhesive film as claimed in claim 1, wherein the adhesive film has an index of refraction of about 1.5 or more.

3. The adhesive film as claimed in claim 1, wherein the adhesive film has a haze of about 2% or less.

4. The adhesive film as claimed in claim 1, wherein the inorganic particles having an index of refraction of about 1.5 or more include zirconia (ZrO₂).

5. The adhesive film as claimed in claim 1, wherein the inorganic particles having an index of refraction of about 1.5 or more have an average particle diameter (D50) of about 10 nm to about 50 nm.

6. The adhesive film as claimed in claim 1, wherein the inorganic particles having an index of refraction of about 1.5 or more are present in the adhesive film in an amount of about 1 wt % to about 50 wt %.

7. The adhesive film as claimed in claim 1, wherein the (meth)acrylic polymer having an aromatic group and a hydroxyl group includes a copolymer of a monomer mixture, the monomer mixture including an aromatic group-containing (meth)acrylic monomer and a hydroxyl group-containing (meth)acrylic monomer.

8. The adhesive film as claimed in claim 7, wherein:
the aromatic group-containing (meth)acrylic monomer includes a compound represented by Formula 1:
CH₂═C(R¹)—C(═O)—O—R²—Ar, [Formula 1]
in Formula 1,
R¹ is a hydrogen atom or a methyl group;
R² is a substituted or unsubstituted C₁ to C₁₀ alkylene group or a substituted or unsubstituted C₁ to C₁₀ alkylene oxide group; and
Ar is a substituted or unsubstituted C₆ to C₂₀ monovalent aromatic hydrocarbon group.

9. The adhesive film as claimed in claim 8, wherein the aromatic group-containing (meth)acrylic monomer includes phenoxy benzyl (meth)acrylate, phenyl phenoxy ethyl (meth)acrylate, 2-hydroxy-3-phenoxy propyl (meth)acrylate, ethoxylated phenyl phenoxy (meth)acrylate, or benzyl (meth)acrylate.

10. The adhesive film as claimed in claim 7, wherein the monomer mixture includes:
about 80 wt % to about 99 wt % of the aromatic group-containing (meth)acrylic monomer, and
about 1 wt % to about 20 wt % of the hydroxyl group-containing (meth)acrylic monomer.

11. The adhesive film as claimed in claim 7, wherein the monomer mixture further includes at least one comonomer, the comonomer including an alkyl group-containing (meth)acrylic monomer, an alicyclic group-containing (meth)acrylic monomer, or a hetero-alicyclic group-containing (meth)acrylic monomer.

12. The adhesive film as claimed in claim 1, wherein the crosslinking agent is an isocyanate crosslinking agent.

13. The adhesive film as claimed in claim 1, wherein the adhesive film composition includes:
about 45 wt % to about 95 wt % of the (meth)acrylic polymer having an aromatic group and a hydroxyl group,
about 1 wt % to about 50 wt % of the inorganic particles having an index of refraction of about 1.5 or more, and
about 0.001 wt % to about 1 wt % of the crosslinking agent.

14. The adhesive film as claimed in claim 1, wherein the adhesive film has:
a peel strength of about 100 gf/inch to about 3,000 gf/inch, and
a value of about 1.5% or less as calculated by Equation 1:
{[Index of refraction of adhesive film]/[peel strength of adhesive film (gf/inch)]}×100. [Equation 1]

15. An optical member, comprising:
an adherend for optical displays; and
the adhesive film as claimed in claim 1 on one surface of the adherend.

16. An optical display comprising the adhesive film as claimed in claim 1.

17. An adhesive film formed of an adhesive film composition, the adhesive film composition comprising:
a (meth)acrylic polymer having an aromatic group and a hydroxyl group;
inorganic particles having an index of refraction of about 1.5 or more; and
a crosslinking agent,
wherein the adhesive film has:
a peel strength of about 100 gf/inch to about 3,000 gf/inch, and a value of about 1.5% or less, as calculated by Equation 1:
{[index of refraction of adhesive film]/[peel strength of adhesive film (gf/inch)]}×100. [Equation 1]

18. An optical member, comprising:
an adherend for optical displays; and
the adhesive film as claimed in claim 17 on one surface of the adherend.

19. An optical display comprising the adhesive film as claimed in claim 17.
